(19) United States
(12) Patent Application Publication
(10) Pub. No.: US 2003/0170902 A1
(43) Pub. Date: Sep. 11, 2003

(54) Automated environmental analytic system with improved sample throughput

(76) Inventors: Eric T. Heggs, Eaton, OH (US); Martin B. Motz, Cincinnati, OH (US); David M. Neal, Hamilton, OH (US)

Correspondence Address: Christopher R. Christenson, WESTMAN CHAMPLIN & KELLY, International Centre - Suite 1600, 900 South Second Avenue, Minneapolis, MN, 55402-3319, US

(21) Appl. No.: 10/092,342

(22) Filed: Mar. 5, 2002

(51) Int. Cl. G01N 35/00; G01N 1/22

(52) U.S. Cl. 436/43; 436/52; 436/161; 436/181; 422/63; 422/83; 422/89

(57) ABSTRACT

A system for analyzing samples using purge and trap concentration is provided. The system includes a plurality of purge and trap concentration units, each adapted to receive a sample and provide a focused analytic sample slug to an analyzer. An analyzer is coupled to each of the plurality of concentrators and receives the focused analytic slugs therefrom. The concentrators are operated in phases from one another.

### BACKGROUND OF THE INVENTION

The present invention relates to automated environmental laboratory analysis. More specifically, the present invention relates to an automated environmental analytic system with improved sample throughput.

Modern environmental testing laboratories are faced with a continuing increase of samples which must be analyzed. These samples can vary substantially and may be related to, among other things, water analysis, and soil composition.

FIG. 1 is a diagrammatic view of an automatic environmental analysis system in accordance with the prior art. System 100 includes multiple vial autosampler 102, purge and trap concentrator 104, and gas chromatograph 106. Autosampler 102 is adapted to receive and maintain a number of vials containing environmental samples. Autosampler 102 is generally equipped with a robotic system to pick a given vial from its respective position and move it to an analyzation site where a sample is removed from the vial. Generally, the sample is tested for volatile organic components. Examples of autosampler 102 can be purchased from Tekmar Company, of Mason, Ohio under the trade designation Solatek 72.

The sample from autosampler 102 is conveyed to purge and trap concentrator 104. The functions of purge and trap concentrators are well known. Purge and trap concentrator 104 is conventional and can be obtained from Tekmar Company under the trade designations Model LSC-1, LSC-2, LSC-3, and 3100. Specifically, a generally diffuse analytic stream is received from an autosampler and provided to an adsorbent trap which accumulates the volatile organic components over time. Once a sufficient amount of adsorption has occurred, the sample flow is ceased and the temperature of the adsorbent trap is heated very rapidly to “desorb” the volatile organic components which can then pass as a highly focused analytic slug into an analyzation device, such as a gas chromatograph, for enhanced analysis. There are a number of additional techniques that can be used, such as cyro-focusing, and the like, wherein the analytic slug can be focused further for additional benefits.

Once the purge and trap operation is complete, the focused slug of analyte is provided to gas chromatograph 106 for analysis. Gas chromatographs are also known and can be obtained from Hewlett Packard Company under the trade designation Model 5890. Generally, gas chromatograph 106 includes a chromatographic column that preferentially adsorbs chemical compounds in an ascending molecular-weight sequence. Based upon the differential adsorption, analysis can provide a relative indication of the different quantities of different molecular-weight substances.

The current problem that exists with respect to this known configuration illustrated in FIG. 1 is that when maximum sample throughput is required, any dead time leads to inefficiency Specifically, since a purge and trap concentrator includes a pair of phases, adsorb/desorb, the focused analytic slug is only provided to the gas chromatograph during the desorb state. Thus, while the sample is adsorbing upon the trap, no focused samples are provided to the gas chromatograph. This creates dead time and is a limitation upon known automatic environmental laboratory testing.

If dead time could be reduced, or eliminated, sample throughput could be increased. This would allow more samples to be done in a given period of time thus reducing testing costs while affording the maximum benefit of the operation for the relatively costly pieces of equipment in modern environmental labs.

### SUMMARY OF THE INVENTION

A system for analyzing samples using purge and trap concentration is provided. The system includes a plurality of purge and trap concentration units, each adapted to receive a sample and provide a focused analytic sample slug to an analyzer. An analyzer is coupled to each of the plurality of concentrators and receives the focused analytic slugs therefrom. The concentrators are operated in phases from one another.

### BRIEF DESCRIPTION OF THE DRAWINGS

FIG. 1 is a diagrammatic view of an automated laboratory testing system in accordance with the prior art.

FIG. 2 is a diagrammatic view of an automated laboratory testing system in accordance with an embodiment of the present invention.

FIG. 3 is a diagrammatic view of a portion of the system illustrated in FIG. 2, shown in greater detail.

### DETAILED DESCRIPTION OF THE PREFERRED EMBODIMENTS

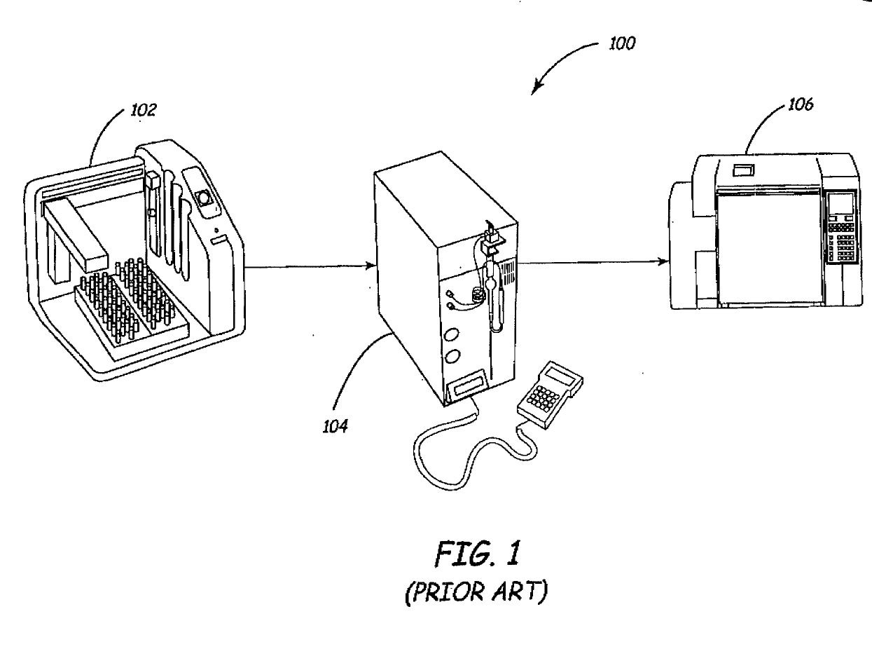

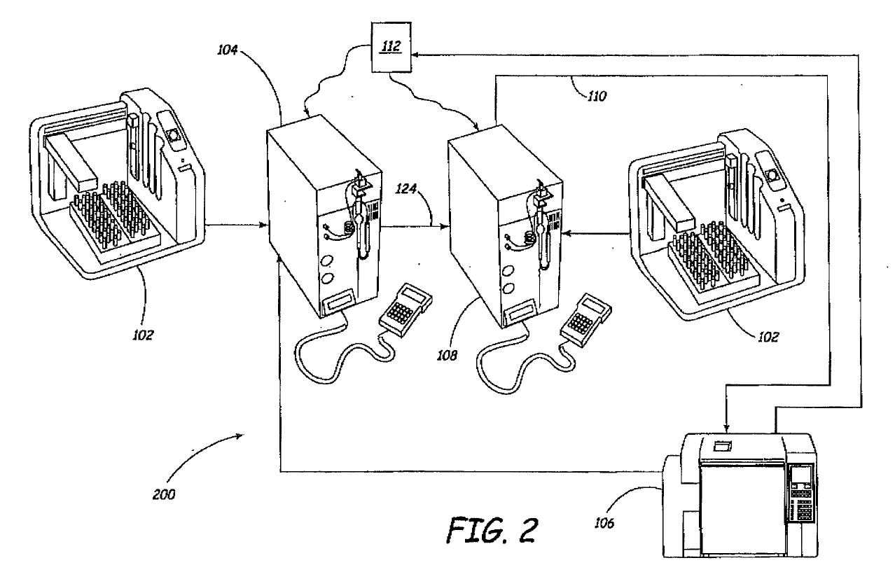

FIG. 2 is a diagrammatic view of environmental laboratory analysis system 200 in accordance with an embodiment of the present invention. System 200 bears some similarities to the system illustrated with respect to FIG. 1, and like components are numbered similarly. System 200 includes a pair of purge and trap concentrators, 104, 108 that receive samples from respective autosamplers 102. As illustrated in FIG. 2, purge and trap concentrator 104 is coupled to purge and trap concentrator 108. Purge and trap concentrator 108 is preferably a conventional purge and trap concentrator, such as the Model 3100 Purge and Trap Concentrator available from Tekmar Company. Concentrator 108 is coupled to analyzation instrument 106 as indicated by line 110. Instrument 106 is coupled to concentrator 104 and provides carrier gas to concentrator 104 via the carrier gas inlet (not shown in FIG. 2) on concentrator 104. Concentrator 104 includes sample transfer line 124 that, instead of being coupled to instrument 106, is provided to a carrier gas inlet (not shown in FIG. 2) on concentrator 108. Then, sample transfer line 110 from concentrator 108 is coupled to instrument 106. In this manner, the two concentrators 104 and 108 are essentially plumbed in series.

In order to facilitate operation with known commercial gas chromatographs, switch box 112 is provided. Known gas chromatographs generate a “GC ready” signal when the gas chromatograph is ready to receive a sample. This signal is generally coupled to a concentrator and used as an indication by the concentrator to provide a sample to the instrument. In order to ensure that concentrators 104 and 108 operate in the correct phase, switch box 112 is used to receive the conventional GC ready signal from analyzation instrument 106 and toggle that signal between concentrators 104 and 108. Thus, when switch box 112 is installed, it allows the “GC ready” signal to only be sent to one concentrator at a time thus eliminating the potential for duplicate injections. Preferably, the cables used in conjunction with switch box 112 are standard cables facilitating connection to known analyzation instruments and purge and trap concentrators.

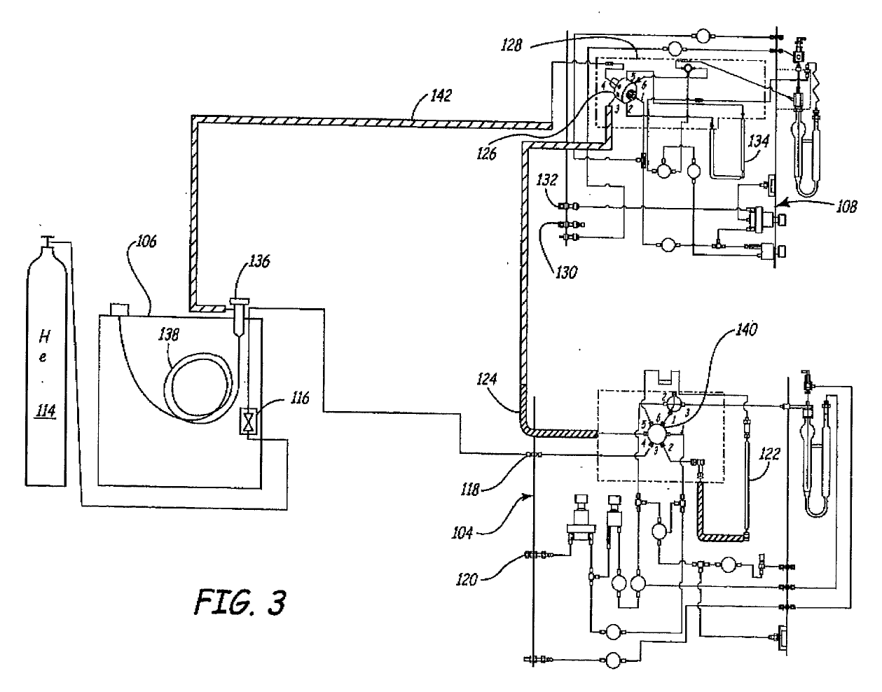

FIG. 3 is a diagrammatic view of a portion of system 200 shown in greater detail. As illustrated, analyzer 106 is coupled to a source of carrier gas, which is preferably helium (He) 114. Source 114 is coupled to flow controller 116 which allows a selectable flow of carrier gas to be provided to carrier gas inlet 118 concentrator 104. Concentrator 104 also includes sample gas inlet 120, which inlet is coupleable to a supply of purge gas. Concentrator 104 operates in accordance with known techniques to receive a sample, adsorb compounds from the sample on trap 122 and subsequently desorb the components thereby passing a focused analytic slug along heated transferred line 124. Thus far, the operation of purge and trap concentrator 104 is conventional. However, instead of coupling the sample transfer line 124 directly to instrument 106, line 124 is provided directly to port 3 on multi-port valve 126 within heated enclosure 128 inside concentrator 108. This arrangement is preferred over merely coupling sample transfer line 124 to desorb gas inlet 130 because the length of piping from inlet 130 to port 3 on valve 126 would not necessarily be heated on a conventional concentrator. Since line 124 serves the dual purpose of conveying focused analytic slug and carrier gas, it is important to maintain line heating along the entire path through which an analytic slug may pass in order to ensure that condensation does not occur. Concentrator 108 also preferably operates in accordance with known techniques to receive a sample; focus the sample upon trap 134 and provide the focused sample to injection port 136 on instrument 106. The focused analytic slugs are then conveyed through chromatograph column 138 and analyzed in accordance with known techniques.

Prior to operation of system 200, a user will generally set up each autosampler 102 with preferably an equal amount of samples on both systems 102. The user will then provide the proper method scheduling into each respective concentrator as if each concentrator were running the system as a stand alone unit. Then, the first system, such as concentrator 104, is started and when that system enters its desorb state, switch 112 will automatically start system #2 (concentrator 108). This effectively puts concentrators 104 and 108 180° out of phase. This means that generally, one concentrator is purging while the other is desorbing. This anti-phase operation is facilitated by the provision of six-port multi-position valves 126 and 140 in concentrators 108 and 104, respectively These multi-position valves generally have two positions wherein a given port will be coupled to the port to its immediate left during one state and coupled to the port to its immediate right during a second state. For example, when concentrator 104 is in its purge mode (also referred to herein as adsorption mode) the ports are coupled as follows: 1-2; 3-4; and 5-6. As should be apparent, during this mode carrier gas flows freely through concentrator 104 into concentrator 108. While concentrator 104 is in its purge mode, concentrator 108 is in desorb mode. In this state, the ports in multi-port valve 126 are coupled as follows: 2-3; 4-5; and 6-1. In this manner, carrier gas received by concentrator 108 from concentrator 104 is guided through trap 134 in order to force the focused analytic slug that has accumulated in trap 134 into port 5 of valve 126, out port 4 of valve 126, through heated transfer line 142, and finally into injection port 136.

When system 200 switches states, the states of concentrators 104 and 108 are reversed. In this state, the port couplings for valve 140 in concentrator 104 are as follows: 2-3; 4-5; and 6-1. Accordingly, concentrator 108 is put into its purge mode during the desorb mode of concentrator 104 and thus the port couplings for valve 126 are as follows: 1-2; 3-4; and 5-6. It should be apparent that the focused analytic slug which has accumulated upon trap 122 and concentrator 104 is forced into port 5 of valve 140, out port 4 of valve 140, through heated transfer line 124 into port 3 of valve 126, out port 4 of valve 126, through sample transfer line 142 into injection port 136. Thus, while one concentrator purges, the other desorbs and vice versa. In this manner, significant dead time is substantially reduced thereby allowing significantly improved sample throughput.

Embodiments of the present invention are particularly amenable to combinations of concentrators provided by Tekmar Company. Specific concentrators include, but are not limited to, the Model LSC-1; LSC-2, LSC-3 and 3100 concentrators. Additionally, while embodiments of the present invention have been described with respect to couplings between the multi-port valve and the respective concentrators, that is merely the preferred embodiment. Additional embodiments of the invention could be provided using additional valves and piping external to the concentrators to split or otherwise control the flow of carrier gas through the respective concentrators.

Although the present invention has been described with reference to preferred embodiments, workers skilled in the art will recognize that changes may be made in form and detail without departing from the spirit and scope of the invention.

What is claimed is:

1. An automated system for analyzing samples, the system comprising:
a first purge and trap concentrator configured to receive a first sample stream;
a second purge a trap concentrator configured to receive a second sample stream; and
an analyzer coupled to the first and second concentrators, the analyzer receiving a first focussed analytic slug from the first during a first state, and a second focussed analytic slug from the second concentrator during a second state.

2. The system of claim 1, wherein the first and second concentrators are fluidically coupled together in series.

3. The system of claim 1, and further comprising a switch box coupled to the analyzer and the first and second concentrators, the switch box receiving an analyzer ready signal from the analyzer and selectively providing the signal to one of the first and second analyzers.

4. The system of claim 1, wherein the analyzer is a gas chromatograph.

5. The system of claim 1, wherein the first concentrator is coupled to the analyzer to receive a flow of carrier gas therefrom.

6. The system of claim 5, wherein the first analyzer has a sample outlet port that is coupled to the second analyzer through a sample transfer line.

7. The system of claim 6, wherein the sample transfer line is coupled directly to a multi-port valve in the second analyzer.

8. The system of claim 7, wherein the sample transfer line is heated.

9. The system of claim 6, wherein the sample transfer line is heated.

10. The system of claim 1, and further comprising:
a first autosampler coupled to the first concentrator to provide the first sample stream; and
a second autosampler coupled to the second concentrator to provide the second sample stream.

11. A method of analyzing samples, the method comprising:
purging a first sample stream onto a first trap to concentrate the first sample stream upon the first trap;
desorbing the first concentrated sample from the first trap to an analyzer and analyzing the first concentrated sample while purging a second sample stream onto a second trap to concentrate the second sample stream upon the second sample trap;
desorbing the second concentrated sample from the second trap to the analyzer and analyzing the second concentrated sample.

12. The method of claim 11, wherein the method is repeated, and wherein during the desorbing and analyzing of the second concentrated sample, the first sample stream is again purged onto the first trap.

13. The method of claim 11, wherein sequencing of the purge and desorb states for the first and second traps is controlled by a switch box coupled to the analyzer.

14. The method of claim 11, wherein analyzing the first and second concentrated samples includes performing gas chromatographic analysis on the first and second concentrated samples.

15. The method of claim 11, wherein the steps of desorbing the first concentrated sample and desorbing the second concentrated sample are mutually exclusive.
